(19) United States
(12) Patent Application Publication
(10) Pub. No.: US 2003/0099533 A1
(43) Pub. Date: May 29, 2003

(54) Fork lift apparatus and methods of lifting and positioning a load

(76) Inventor: Louis Marrero, Titusville, FL (US)

Correspondence Address: Jeffrey S. Whittle, Bracewell & Patterson, L.L.P., 711 Louisiana Street, Suite 2900, Houston, TX, 77002-2781, US

(21) Appl. No.: 09/995,211

(22) Filed: Nov. 27, 2001

(51) Int. Cl. B65G 1/00

(52) U.S. Cl. 414/631

(57) ABSTRACT

A fork lift apparatus and methods for moving a load in a predetermined narrow area and capable of multi-directional movement are provided. The fork lift apparatus preferably includes an elongate base having a recess formed in a medial portion thereof. The fork lift apparatus can also include a fork lift frame connected to the elongate base. The fork lift frame can include a first pair of fork lift frame guide rails for guiding the fork lift frame between an extended and a retracted position. The fork lift apparatus can further include a fork lift connected to the fork lift frame. The fork lift preferably includes a lift base, a fork guide positioned to overlie the lift base, and a second pair of spaced-apart fork lift frame guide rails positioned to overlie the lift base for guiding the fork guide between an elevated position and a lowered position. The fork lift apparatus can still further include an operator station connected to the fork lift frame in a fixed and elevated position to provide an operator with an unobstructed view over a load when positioned on the fork lift.

### FIELD OF THE INVENTION

The present invention relates to the cargo transport industry and more particularly, the field of transporting cargo within narrow areas and associated methods.

### BACKGROUND OF THE INVENTION

Fork lifts have been generally known for many years and have been widely used in such areas as warehouses to move loads placed on pallets, for example. One way that large warehouses can better utilize their space is to increase the number of aisles of products within the warehouse. This has led to the use of narrower aisles within the warehouse. Therefore, a problem that arose with the use of traditional fork lifts, i.e., front-loading fork lifts, is that they can no longer effectively be used in warehouses having narrower aisles. Traditional front-loading fork lifts cannot be positioned to maneuver an elongate load in a balanced manner so that a longitudinal axis of the elongate load is parallel with the longitudinal axis of a typical narrow aisle. Therefore, these elongate loads were normally moved using manual labor which can be costly and time consuming or using some other form of machinery that can only be dedicated to the movement of these elongate loads, such as overhead crane or pulley and hoist systems. These systems can prove to be costly, difficult to install, and require extensive training for operation.

Side loading fork lifts have previously been used to maneuver loads within narrow areas. For example, U.S. Pat. No. 3,757,899 titled “Double Mast Side Loader Lift Truck and Double Actuator Balancing” by Smith, Jr., describes a side loader lift truck that moves in forward and rearward directions. The side loader lift truck described in Smith Jr. '899 also includes forks that laterally extend from the lift truck. The side loader lift truck described in Smith Jr. '899, however, is disadvantageous when trying to conserve time and manual labor cost because it is only adapted to move in either forward or rearward directions. This can also disadvantageously limit maneuverability capabilities of the side loader lift truck which can be important when moving loads in a narrow area. The operator's platform described in Smith Jr. '899 is adjustable along with the load. This can be disadvantageous because of the danger presented to the operator, i.e., being moved vertically up and down with a heavy or elongate load.

Another type of loading apparatus is illustrated and described in U.S. Pat. No. 2,773,612 titled “Apparatus For Loading and Unloading Trailers and The Like Onto and From Platforms and The Like” by West et al. This loading apparatus loads and unloads trailers, i.e., tractor trailers that are transported by large trucks from railroad cars. The lifting forks are positioned to surround the tires of the trailer to be lifted. The lifting apparatus also includes a set of driven wheels that operate similar to the wheels of a vehicle, i.e., forward and rearward travel. The lifting apparatus also includes a pair of the wheels adapted to pivot to thereby steer the vehicle. The lifting apparatus further includes another set of support wheels that are positioned to support a load, e.g., the trailer, when being loaded onto or unloaded off of the railroad car. This configuration is disadvantageous because in order for the operator to maneuver the vehicle in any other direction except for forward and rearward, a plurality of “turns” must be performed. For example, in order for the lifting apparatus to be moved closer to or further from the railroad car, a series of turns, i.e., three-point turns, must be performed. This disadvantageously requires a high level of training, precision, and extended periods of time on the part of the operator. A risk that is presented by the apparatus described in West '612, is that the operator is positioned at a lower fixed elevation. This can prove to be dangerous as it may be difficult for the operator to visualize an area positioned directly in front of the load. For example, an obstacle or a person can be easily hit or injured if positioned in front of the lifting apparatus and not visualized by the operator.

### SUMMARY OF THE INVENTION

With the foregoing in mind, the present invention advantageously provides a fork lift apparatus and associated methods that are advantageously adapted to easily move in forward, rearward, lateral, and transverse directions to solve the problem of limited maneuverability of a cargo handling device in a narrow area. The present invention also advantageously identifies the source of the problems associated with increased time necessary to maneuver loads in narrow areas. The present invention further advantageously solves the problem of hazards that are encountered when an operator does not have a clear and unobstructed view of an area surrounding the fork lift apparatus. The present invention still further recognizes the problem associated with an operator having an obstructed view when operating the fork lift apparatus and advantageously provides the unique solution of a fixed and elevated operator station so that an operator positioned therein will have an unobstructed view of an area surrounding the fork lift apparatus. The present invention also advantageously recognizes the problem of stabilizing a load positioned on a fork lift apparatus so as to prevent the load from falling off of the fork lift apparatus during transport. The present invention further advantageously recognizes the problem of transporting loads in an unbalanced manner and provides the elegant solution of providing counter weights so as to advantageously counter balance the weight of a load positioned on the fork lift apparatus.

More particularly, the fork lift apparatus of the present invention preferably includes an elongate base having a front, a rear, and first and second sides extending between the front and the rear. The first side preferably is positioned substantially opposite the second side and includes a recess formed in a medial portion thereof to thereby define a recessed medial base portion. The fork lift apparatus also preferably includes a first pair of spaced-apart fork lift frame guide rails connected to a respective side wall of the recessed medial base portion. The fork lift apparatus of the present invention further preferably includes a fork lift frame positioned to overlie the recessed medial base portion and slidably connect to the pair of fork lift frame guide rails so that the fork lift frame is positioned between a retracted position and an extended position as the fork lift frame slidably moves along the first pair of fork lift frame guide rails. The fork lift frame further preferably includes a fork lift connected to the fork lift frame. The fork lift frame also preferably includes a lift base to support the fork lift during movement between the retracted position and the extended position of the fork lift frame.

The fork lift frame of the present invention also preferably includes a plurality of omni-directional wheels positioned adjacent a bottom portion of the elongate base and a controller to control the movement of the plurality of omni-directional wheels, the fork lift frame, and the fork lift. The fork lift apparatus further preferably includes a drive assembly connected to the elongate base, the fork lift frame, the fork lift, the plurality of omni-directional wheels, and the controller to drive the plurality of omni-directional wheels, the fork lift frame and the fork lift responsive to the controller.

The present invention also advantageously includes a method of positioning a load within a predetermined narrow area using a fork lift apparatus having an elongate base with a longitudinal axis. The method preferably includes longitudinally moving the fork lift apparatus in a first predetermined direction along a longitudinal axis of the narrow area so that the longitudinal axis of the elongate base is positioned parallel to the longitudinal axis of the narrow area. The method also preferably includes extending a fork lift from a retracted position to engage and lift the load. The method further preferably includes laterally moving the fork lift apparatus in a second predetermined direction so that the longitudinal axis of the elongate base is positioned substantially perpendicular to the longitudinal axis of the narrow area.

The fork lift apparatus and associated methods of the present invention advantageously allows a fork lift apparatus having a load positioned thereon to be maneuvered in a plurality of directions, i.e., forward, rearward, lateral, and transverse directions. This advantageously allows a load to be readily positioned within a narrow area in a time efficient and cost effective manner. The retraction and extension capabilities of the fork lift apparatus of the present invention also advantageously allows for effective and balanced movement of the fork lift apparatus when a load is positioned thereon. The fork lift apparatus further advantageously includes a plurality of spaced-apart prong members that can advantageously be moved to accommodate various sized loads to thereby provide support for elongate loads having various lengths and sizes.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a perspective view of a fork lift apparatus according to the present invention;

FIG. 2 is a front perspective view of a fork lift apparatus having portions broken away to show a drive assembly according to the present invention;

FIG. 3 is a fragmentary perspective view of an operator control unit of a fork lift apparatus according to the present invention;

FIG. 4 is a fragmentary perspective view of a fork lift apparatus having an operator station positioned in an extended position according to the present invention;

FIG. 5 is an environmental top plan view of a warehouse having aisles and a fork lift apparatus being maneuvered in a plurality of directions according to the present invention; and

FIG. 6 is a fragmentary perspective view of an operator seat positioned within an operator station of a fork lift apparatus according to the present invention.

### DETAILED DESCRIPTION OF THE PREFERRED EMBODIMENTS

The present invention will now be described more fully hereinafter with reference to the accompanying drawings which illustrate preferred embodiments of the invention. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, the prime notation, if used, indicates similar elements in alternative embodiments.

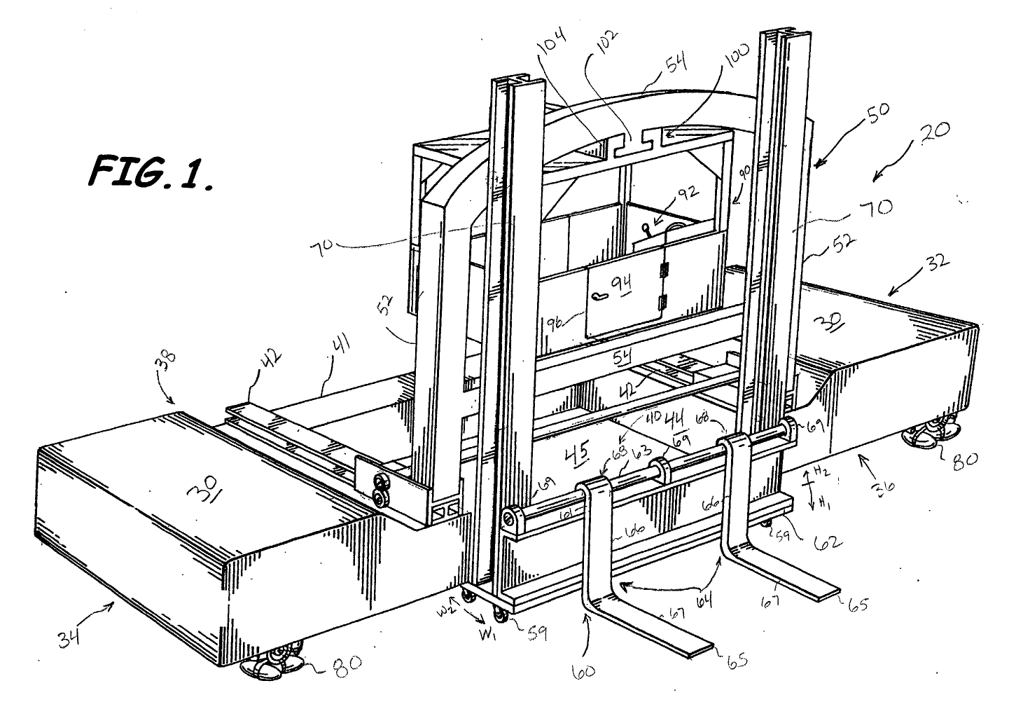

As illustrated in FIGS. 1-6 the present invention advantageously provides a fork lift apparatus 20 and associated methods for maneuvering a load L in a predetermined narrow area A. More particularly, as perhaps best illustrated in FIG. 1, the present invention preferably provides a fork lift apparatus 20 adapted to move a predetermined load L within a predetermined area A such as a narrow aisle. The fork lift apparatus 20 preferably includes an elongate base 30 having a front 32, a rear 34, and first and second sides 36, 38 extending between the front 32 and the rear 34. Although other configurations can be used as well, the first side 36 preferably is advantageously positioned substantially opposite the second side 38. The elongate base 30 can advantageously be made of a heavy duty metal material, for example, or any other material that is substantially resistant to external impact, as understood by those skilled in the art. The elongate base also preferably includes a recess 40 formed in a medial portion thereof. More particularly, the recess 40 is preferably positioned to extend inwardly from outer surface peripheries of the first side 36 of the elongate base 30 toward the second side 38 of the elongate base 30 so that a rear wall of the recess 41 is positioned adjacent a second side 38 of the elongate base 30 to thereby define a recessed medial base portion 45 of the elongate base 30.

The recessed medial base portion 45 preferably has a first pair of spaced-apart fork lift frame guide rails 42 as perhaps best illustrated in FIG. 1. Each of the first pair of spaced-apart fork lift frame guide rails 42 is preferably connected to a respective side wall 44 of the recessed medial base portion 45. Each side wall 44 is preferably connected to and extend outwardly from the rear wall 41 of the recessed medial base portion 45 toward the outer surface peripheries of the first side 36 of the elongate base 30 as illustrated.

The fork lift apparatus 20 of the present invention also preferably includes a fork lift frame 50 connected to the elongate base 30. The fork lift frame 50 can be positioned to overlie the recessed medial base portion 45 as shown. The fork lift frame 50 can also be adapted to overlie the recessed medial base portion 45 and portions of the elongate base 30. The fork lift frame 50 preferably includes fork lift frame guide means for guiding the fork lift frame 50 between an extended position and a retracted position W₁, W₂. The fork lift frame guide means can advantageously be provided by a fork lift frame guide that is preferably positioned to engage portions of the fork lift frame 50 and thereby position the fork lift frame 50 between the extended and retracted positions W₁, W₂. The fork lift frame guide means can also advantageously be provided by a pair of spaced-apart and opposing side frame members 52 each positioned to slidably connect to a respective one of the first pair of spaced-apart fork lift frame guide rails 42 and to extend upwardly therefrom. The fork lift frame guide means can further advantageously include at least one brace member 54 connected to and extending between upper end portions of the pair of side frame members 54 so that the fork lift frame 50 can be positioned between a retracted position and an extended position W₁, W₂ as the fork lift frame 50 slidably moves along the first pair of fork lift frame guide rails 42. As perhaps best illustrated in FIG. 1, the brace member 54 can advantageously include a top brace member and a bottom brace member. The top and bottom brace members are preferably positioned to extend between the side frame members 52 to thereby enhance the strength of the fork lift frame 50.

The fork lift apparatus 20 of the present invention further preferably includes a fork lift 60 connected to the fork lift frame 50. The fork lift 60 advantageously has a lift base 62 and a fork guide 63 positioned to overlie the lift base 62. The fork guide 63 can, for example, be provided by an elongate bar having a length that is shorter than the width of the recessed medial base portion 45. This advantageously allows the fork guide 63 to be positioned between the sidewalls 64 of the recessed medial base portion 45. The fork guide 63 can also advantageously be provided by a rail positioned to extend across a front portion of the fork lift 60. The rail can be welded, for example, to the front of the fork lift 60, or connected in any other manner that would adequately secure the fork guide 63 to the fork lift 60, as understood by those skilled in the art. A plurality of fork guide receivers 69 adapted to slidably receive portions of the fork guide 63 are preferably positioned along the peripheries of the lift base 62 to connect the fork guide 63 to the lift base 62. At least one of the plurality of fork guide receivers 69 can advantageously be threaded, for example. Similarly, a portion of the fork guide 63 corresponding to the threaded fork guide connector 69 can also be threaded so that the fork guide 63 can advantageously be connected to the fork guide receivers 69 by a threaded connection. Although a threaded connection is described above, it will be understood by those skilled in the art that any connection that will secure the fork guide receivers 69 to the fork guide 63 can also be used as well.

The fork guide 63 also preferably includes a pair of prong members 64 connected thereto. As perhaps best illustrated in FIGS. 1, 2, and 4, each of the pair of prong members 64 can advantageously have an “L-shape”, for example. The “L-shape” preferably includes a vertically extending back leg portion 66 and a horizontally extending bottom leg portion 67. The vertically extending back leg portion 66 of each of the pair of prong members 64 can advantageously include a proximal and a distal end portion 61, 65. The proximal end portion 61 preferably includes a prong connecting member 68 adapted to connect the proximal end portion 61 of each of the prong members 64 to the fork guide 63. The prong connecting member 68 can advantageously be provided by a hooked end portion, for example, positioned to extend from the proximal end portion of the prong members 64. The hook can advantageously be positioned to overlie or connect the fork guide 63. The prong connecting member 68 can also advantageously be provided by a looped end portion having a hinge so that the loop can be opened to be placed around portions of the fork guide 63 and closed to thereby secure the looped end portion to the fork guide 63. The vertically extending back portion 66 of the prong members 64 can advantageously be used as a support. For example, the vertically extending back portion 66 of the prong members 64 can be positioned to rest against the lift base 62 to thereby enhance support of a load L positioned on the prong members 64.

The lift base 62 of the fork lift 60 is adapted to support the fork lift 60 during movement between the retracted position and the extended position W₁, W₂ of the fork lift frame 50. The lift base 62 preferably includes a plurality of wheels 59 connected thereto to thereby define a wheeled lift base. Each of the plurality of wheels 59 connected to the lift base 62 advantageously can be adapted for forward and rearward movement so that the lift base 62 can advantageously be extended out of and retracted into the recessed medial base portion 45 of the elongate base 40. Each of the plurality of wheels 59 also advantageously can be adapted for lateral movement so that the lift base 62 can advantageously move in lateral directions when the fork lift apparatus 20 is moved in lateral directions. Each of the plurality of wheels 59 can advantageously be provided by castors, for example, or any other wheel that can be adapted for multidirectional movement as understood by those skilled in the art.

The fork lift 60 further preferably includes fork lift guide means positioned to overlie the lift base 62 for guiding the fork guide 63 between an elevated position H₁ and a lowered position H₂. The fork lift guide means can advantageously be provided by a fork lift guide, for example, that is preferably positioned to engage the fork lift 60 so as to guide the fork guide 63 between the elevated and lowered positions H₁, H₂. The fork lift guide means can also advantageously be provided by a second pair of spaced-apart fork lift guide rails 70 connected to and extending upwardly from the lift base 62. The second pair of spaced-apart fork lift guide rails 70 are preferably adapted to receive and move the fork guide 63 between the elevated position H₁ and the lowered position H₂.

The pair of spaced-apart prong members 64 are preferably positioned to slidably connect to the fork guide 63 so that the pair of prong members 64 are adapted to move between an open position and a closed position. For example, when the fork lift apparatus 20 is used to transport an elongate load L, the pair of spaced-apart prong members 64 can advantageously be positioned in the open position so that the spacing between the pair of prong members 64 is increased to thereby enhance balance of the elongate load L being transported by the fork lift apparatus 20. Similarly, when the fork lift apparatus 20 is used to transport a narrow load L, the pair of spaced-apart prong members 64 can be positioned in the closed position so that the spacing between the pair of prong members 64 is decreased to thereby enhance balance of the narrow load L.

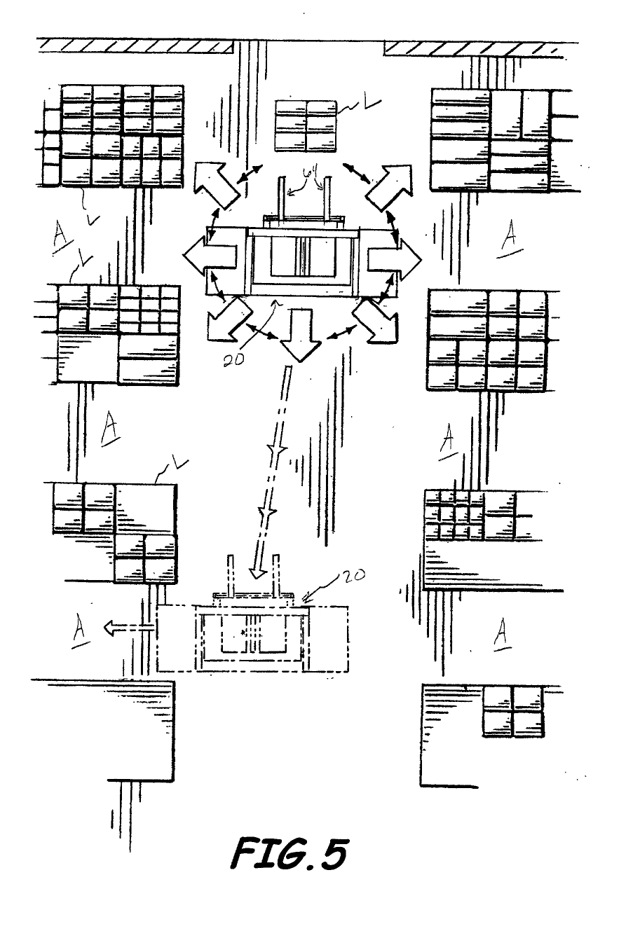

The fork lift apparatus also preferably includes a plurality of wheels 80, e.g., preferably omni-directional wheels, positioned adjacent a bottom portion of the elongate base 30. As perhaps best illustrated in FIG. 5, each of the plurality of omni-directional wheels 80 are preferably adapted to move the fork lift apparatus 20 in forward, rearward, lateral, and transverse or oblique directions. The plurality of omni-directional wheels 80 preferably includes four spaced-apart omni-directional wheels 80 positioned along opposing bottom corner end portions of the elongate base 30. Although four omni-directional wheels are preferred, any number of omni-directional wheels 80 can be used and positioned along the bottom portion of the elongate base 30 so that the elongate base 30 can be adapted to move in forward, rearward, lateral, and transverse or oblique directions. The omni-directional wheels 80 can advantageously be made of a molded hard plastic material, a metal material, or any other type of material having high strength properties and low deformation properties as understood by those skilled in the art. A more detailed description of the omni-directional wheels can be found in U.S. Pat. No. 6,134,734 by the same inventor of the present invention and titled Aircraft Maintenance Apparatus and Method of Maintaining Aircraft, and U.S. patent application Ser. No. ______, filed on Oct. 10, 2001 also by the same inventor of the present invention and titled Omni-Directional Wheel and Associated Methods. Both the issued patent and pending application are incorporated herein by reference in their entireties.

The fork lift apparatus 20 of the present invention further preferably includes an operator station 90 connected to an upper portion of a fork lift frame 50 to provide an operator with an unobstructed view over a load L when positioned on the fork lift 60. The operator station 90 preferably includes a base and a plurality of sidewalls positioned to extend upwardly from the base. The operator station can also include a top cover positioned to overlie the sidewalls to thereby provide a cover positioned over the operator. The top cover can advantageously have dimensions that are substantially larger than the base so that the top cover over hangs the sidewalls of the operators station 90 to enhance protection of the operator positioned within the operator station from objects that may fall from above the fork lift apparatus 20. The operator station 90 preferably includes a controller 92 positioned to control the movement of the plurality of omni-directional wheels 80 connected along the bottom of the elongate base 30. The controller 92 advantageously is preferably used to control the movement of the fork lift frame 50 and the fork lift 60. The operator station 90 is preferably elevated to a position substantially higher than the load L when positioned on the pair of prong members 64 of the fork lift 60. This advantageously insures that an operator positioned in the operator station 90 has a clear and unobstructed view over the load L regardless of whether the load L is positioned in the elevated or lowered position H₁, H₂. The operator station 90 further preferably includes an operator station access 94 connected to the operator station 90 and the fork lift frame 50 to provide ready access to the operator station 90. As perhaps best illustrated in FIG. 2, the operator station access 94 can advantageously include a ladder 95, for example, positioned to extend upwardly along one of the plurality of side frame members 52. The operator station access 94 can further advantageously include a door positioned along outer peripheries thereof so as to provide access from exterior the operator station 90 to interior the operator station 90. For example, the operator can climb up the ladder 95 positioned along one of the side frame members 52 of the fork lift frame 50 and open the door connected to the operator station to thereby gain access to the operator station 90. The operator station door can advantageously be adapted to open inwardly, outwardly, or can slide so as to provide access to the operator station 90.

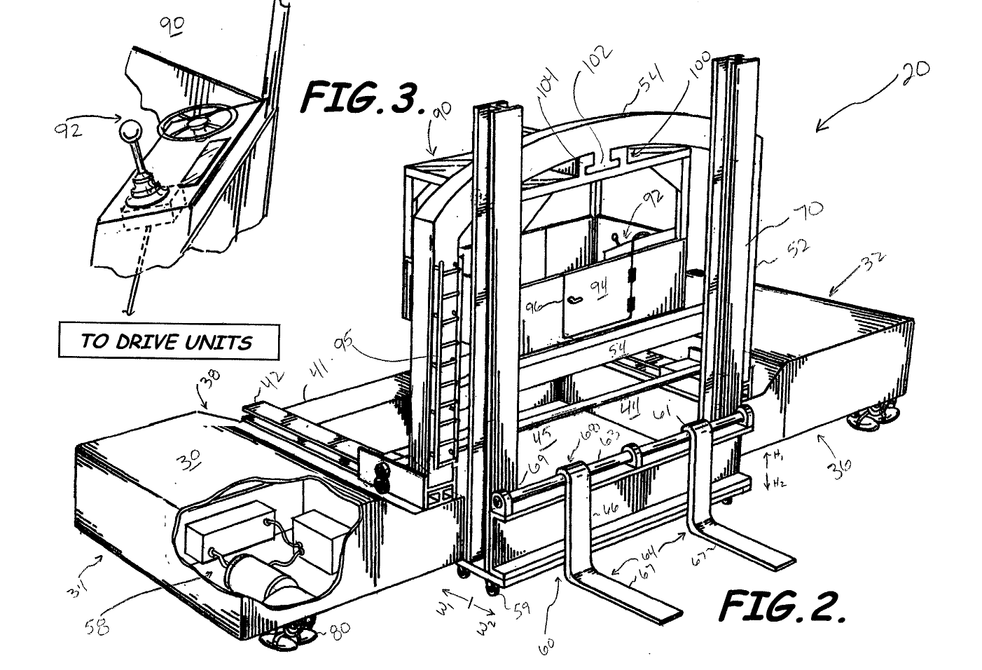

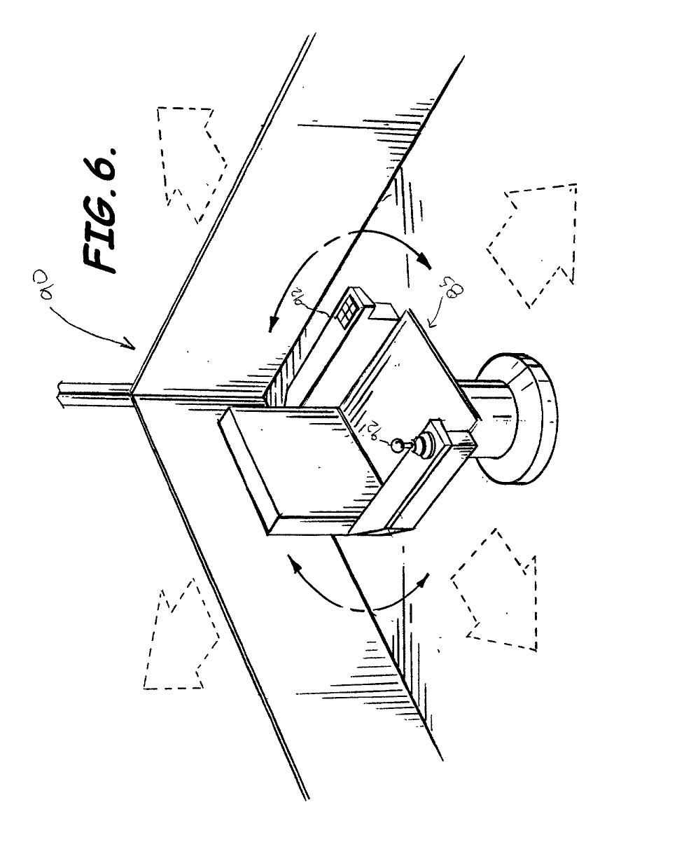

As perhaps best illustrated in FIGS. 3 and 6, the controller 92 can advantageously be provided by a stick, e.g., a joystick, or drive assembly that is responsive to the operator positioned in the operator station 90 and is connected to drive units, e.g., drives, processors, motors, and position sensors as understood by those skilled in the art. The stick can include various positions that represent the desired movement of the fork lift apparatus 20. For example, when the stick is positioned in the forward position, the fork lift apparatus 20 can be positioned to move forward. Likewise, when the stick is retracted to a rearward position, the fork lift apparatus 20 can be positioned in a rearward direction. The controller 92 can also advantageously be provided by a combination of a forward/rearward lever and a wheel, for example, to provide a combination of forward/rearward movement and turning capabilities thereby providing multidirectional movement. The controller 92 advantageously allows the operator to control the multi-directional movement of the omni-directional wheels 80, the extension and retraction of the fork lift frame 50, and the elevation of the fork lift 60.

As best illustrated in FIG. 6, the operator station 90 also preferably includes an operator seat 85. The operator seat 85 can advantageously be moved into various positions so that the operator is positioned to face the direction of movement of the fork lift apparatus 20. The operator seat 85 can include a manual seat position adjuster, such as a lever, for example, that when engaged allows the operator seat 85 to be moved in various positions. The operator seat 85 can also advantageously include an automatic seat position adjuster that will automatically adjust the position of the operator seat 85 depending on the direction of movement of the fork lift apparatus 20. This advantageously insures that the operator is always facing in the same direction as the direction of movement of the fork lift apparatus 20. The operator seat 85 can further advantageously have the controller 92 connected thereto. For example, the controller 92 can be positioned adjacent one of the arms of the operator seat 85. This advantageously allows an operator ready access to the controller 92 without the need to strain to reach the controller 92.

As perhaps best illustrated in FIGS. 1, 2, and 4, the fork lift apparatus 20 of the present invention also preferably includes operator station 90 connecting means for connecting the operator station to the fork lift frame 50 of the fork lift apparatus 20. The operator station connecting means advantageously is preferably provided by an operator station connector 100 connected to the fork lift frame 50 to connect the operator station 90 to the fork lift frame 50. The operator station connector 100 preferably includes a first and a second operator station connector 102, 104. The first operation station connector 102 is connected to the fork lift frame 50 and the second operator station connector 104 is connected to the operator station 90. The first and second operator station connectors 102, 104 can advantageously be adapted to slidably engage one another to thereby connect the operator station 90 to the fork lift frame 50. The first operator station connector 102, for example, can be provided by a lip portion extending down from a top brace member of the fork lift frame 50. The lip, for example, can be a male connector adapted to be inserted into the second operator station connector 104. The second operator station connector 104 can be a channel portion, for example, positioned to extend upwardly from a top portion of the operator station 90. The inner portion of the channel can therefore have a shape substantially similar to the lip of the first operator station connector 102, and can advantageously be a female connector portion to receive the male connector portion of the first operator station connector 102. The first operator station connector 102 can therefore be positioned to slidably engage the second operator station connector 104 to thereby connect the operator station 90 to the fork lift frame 50.

As best perhaps illustrated in FIG. 2, the fork lift apparatus 20 of the present invention further preferably includes a drive assembly 58 connected to the elongate base 30, the fork lift frame 50, the fork lift 60, the plurality of omni-directional wheels 80, and the controller 92. As will be readily understood by those skilled in the art, the drive assembly 58 is preferably adapted to drive the plurality of omni-directional wheels 80, the fork lift frame 50, and the fork lift 60, responsive to the controller 92. The communication between the drive assembly 58 and the controller 92 can advantageously be a hard wire connection, for example, or radio frequency, infrared, or any other type of communication as understood by those skilled in the art. When the drive assembly 58 receives a signal from the controller 92, that signal is then transmitted to the fork lift frame 50, the fork lift 60, and the plurality of omni-directional wheels 80 to thereby move the fork lift frame 50 between the retracted and extended position W₁, W₂, the fork lift 60 between the elevated and lowered position H₁, H₂, and the plurality of omni-directional wheels 80 in any number of a plurality of directions.

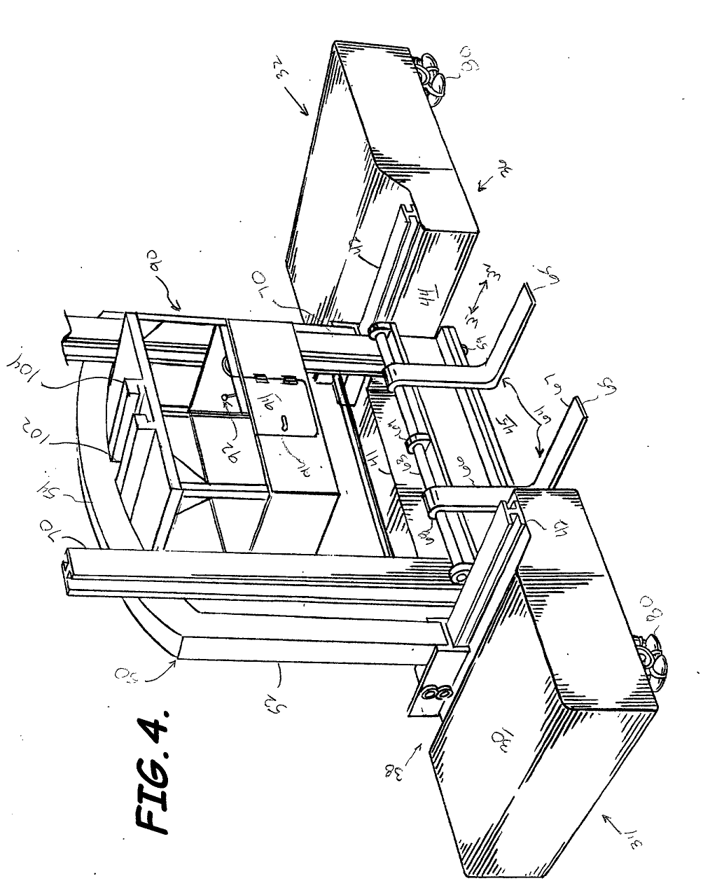

The retracted position W₁ of the fork lift frame 50 is preferably defined by the fork lift frame 50 being positioned closely adjacent the rear wall 41 of the recessed medial base portion 45. Similarly, the extended position of the fork lift frame 50 can be defined by the fork lift frame 50 being positioned spaced-apart from the rear wall 41 of the recessed medial base portion 45 and adjacent the outer surface peripheries of the first side 36 of the elongate base 30. When the fork lift frame 50 is positioned in a retracted position W₁, the total width of the elongate base 30 is advantageously narrower than when the fork lift frame 50 is positioned in the extended position. A more narrow base will more readily fit in a narrow aisle. For example, when the fork lift frame 50 is positioned in the extended position W₂, the fork guide 63 and prong members 64 are positioned adjacent the outer peripheries of the elongate base 30. When the fork lift frame 50 is positioned in the retracted position W₁, however, the fork guide 63 and prong members 64 are positioned adjacent the rear wall 41 of the recessed medial base portion 45. Therefore, as perhaps best illustrated in FIG. 4, the prong members 64 are retracted so as to not protrude out of or outside of the recessed medial base portion 45. The fork lift frame 50 and fork lift 60 are positioned between the extended and retracted positions W₁, W₂, as respectively illustrated in FIGS. 1 and 4, by moving the side frame members 52 of the fork lift frame 50 along the first pair of fork lift guide rails 42 and the fork lift 60 on the lift base 62. The wheels 59 on the lift base 62 can advantageously be positioned either to contact a support surface, such as a warehouse floor, or spaced-apart from a support surface. When the wheels 59 of the lift base 62 are positioned in contact with the support surface, the lift base 62 can be readily moved between the extended and retracted positions W₁, W₂, regardless of whether the wheels 59 of the lift base 62 contact the support surface. It is preferable, however, and more advantageous for the wheels 59 of the lift base 62 to be in contact with the support surface so as to provide added support to the fork lift 60 when a load L is positioned thereon.

The fork lift apparatus 20 of the present invention is preferably adapted to be balanced in weight regardless of the bad load positioned thereon. For example, in order to prevent the fork lift apparatus 20 from tipping over due to unbalanced weight, a counter weight is preferably used. The rear wall 41 of the recessed medial base portion 45 can advantageously include a ballast beam to thereby balance the fork lift apparatus 20 when a load L is positioned on the fork lift 60. The ballast of the rear wall 41 of the recessed medial base portion 45 is even more advantageous when a load L is being lifted by the fork lift 60. Similarly, the weight of the operator station 90, the weight of the operator positioned in the operator station 90 and the weight of the elongate base 30, can all act as counter balancing weights to a load L positioned on the prong members 64 of the fork lift 60. Similarly, the weight of the elongate base 30 and the fork lift frame 50 can also advantageously enhance the counter weights applied to thereby allow a larger and heavier load L to be lifted by the prong members 64 of the fork lift 60.

The present invention also preferably includes a method of positioning a load L within a predetermined narrow area A using a fork lift apparatus 20 having an elongate base 30 with a longitudinal axis. As perhaps best illustrated in FIG. 5, the method preferably includes longitudinally moving the fork lift apparatus 20 in a first predetermined direction along a longitudinal axis of the narrow area A so that the longitudinal axis of the elongate base is positioned substantially parallel to the longitudinal axis of the narrow area A. The method also preferably includes extending a fork lift 60 from a retracted position W, to engage and lift the load L. The method further preferably includes laterally moving the fork lift apparatus 20 in a second predetermined direction so that the longitudinal axis of the elongate base 30 is positioned substantially perpendicular to the longitudinal axis of the narrow area A. The lateral and longitudinal movement of the fork lift apparatus 20 can advantageously be accomplished simultaneously. For example, when the elongate base is being positioned in the longitudinal direction, it can also advantageously be moved in a lateral direction as defined above. The method of positioning the load L within the predetermined narrow area A still further preferably includes moving the fork lift apparatus 20 in a third predetermined direction so that the longitudinal axis of the elongate base 30 is transverse to the longitudinal and lateral axes of the predetermined narrow area A. Therefore, the fork lift apparatus 20 is capable of moving in lateral, longitudinal, and transverse directions.

The method also preferably includes rotating the fork lift apparatus 20 within the predetermined narrow area A. The method can also advantageously include retracting the fork lift 60 from an extended position so that the load L positioned on the fork lift 60 overlies the elongate base 30 and maneuvering the elongate base 30 while the load is positioned on the fork lift 60 of the fork lift apparatus 20. The method further preferably includes unloading the fork lift 60 by extending the fork lift 60 to an extended position, positioning the load L on the support surface and retracting the fork lift 60 to a retracted position W₁ and diagonally moving the fork lift apparatus 20 in a predetermined direction so that the longitudinal axis of the fork lift apparatus 20 is positioned transverse to the longitudinal axis of the predetermined narrow area A. The method of moving the load L in the predetermined narrow area A still further preferably includes viewing an area surrounding the predetermined narrow area A from an elevated and stationary position when the load L is lifted, i.e., the operator station 90 and maneuvering the load L within the predetermined narrow area A while maintaining visibility of the area surrounding the predetermined narrow area A.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims.

That claimed is:

1. A fork lift apparatus comprising:
an elongate base having a front, a rear and first and second sides extending between the front and the rear, the first side being positioned substantially opposite the second side and having a recess formed in a medial portion thereof, the recess extending inwardly from outer surface peripheries of the first side toward the second side so that a rear wall of the recess is positioned adjacent the second side to thereby define a recessed medial base portion of the elongate base, the recessed medial base portion having a first pair of spaced-apart fork lift frame guide rails each connected to a respective side wall of the recessed medial base portion, each side wall being connected to and extending outwardly from the rear wall toward the outer surface peripheries of the first side;
a fork lift frame positioned to overlie the recessed medial base portion and having a pair of spaced-apart and opposing side frame members each positioned to slidably connect to a respective one of the first pair of spaced-apart fork lift frame guide rails and to extend upwardly therefrom, and a brace member connected to and extending between upper end portions of the pair of side frame members so that the fork lift frame is positioned between a retracted position and an extended position as the fork lift frame slidably moves along the first pair of fork lift frame guide rails;
a fork lift connected to the fork lift frame and including a lift base to support the fork lift during movement between the retracted position and the extended position of the fork lift frame and having a plurality of wheels connected thereto to thereby define a wheeled lift base, a second pair of spaced-apart fork lift guide rails connected to and extending upwardly from the wheeled lift base, a fork guide positioned to slidably engage the second pair of fork lift guide rails, overlie the wheeled lift base, and adapted to be positioned between an elevated and a lowered position, and a pair of spaced-apart prong members positioned to slidably connect to the fork guide so that the pair of prong members move between an open position and a closed position;
a plurality of omni-directional wheels positioned adjacent a bottom portion of the elongate base;
an operator station connected to the fork lift frame to provide an operator positioned in the operator station an unobstructed view over a load positioned on the pair of prong members, the operator station having a controller to control the movement of the plurality of omni-directional wheels, the fork lift frame, and the fork lift; and
a drive assembly connected to the elongate base, the fork lift frame, the fork lift, the plurality of omni-directional wheels, and the controller to drive the plurality of omni-directional wheels, the fork lift frame, and the fork lift responsive to the controller.

2. The fork lift apparatus as defined in claim 1, wherein the retracted position of the fork lift frame is further defined by the fork lift frame being positioned closely adjacent the rear wall of the recessed medial base portion and wherein the extended position of the fork lift frame is further defined by the fork lift frame being positioned spaced-apart from the rear wall of the recessed medial base portion and adjacent the outer surface peripheries of the first side of the elongate base.

3. The fork lift apparatus as defined in claim 2, wherein the rear wall of the recessed medial body portion further comprises a ballast beam to thereby balance the fork lift apparatus when the load is positioned on the fork lift.

4. The fork lift apparatus as defined in claim 3, wherein the plurality of wheels connected to the wheeled lift base are adapted to move in a forward direction or a rearward direction when positioned in contact with a support surface.

5. The fork lift apparatus as defined in claim 4, further comprising an operator station connector connected to the fork lift frame to connect the operator station to the fork lift frame, the operator station connector comprising a first and a second operator station connector, the first operator station connector positioned to connect to the fork lift frame and the second operator station connector positioned to connect to the operator station and slidably engage the first operator station connector to thereby connect the operator station to the fork lift frame.

6. The fork lift apparatus as defined in claim 5, wherein the operator station is elevated to a position substantially higher than the load positioned on the pair of prong members and further comprises an operator station access connected to the operator station and the fork lift frame for providing ready access to the operator station.

7. The fork lift apparatus as defined in claim 6, wherein the controller further comprises a stick that is responsive to the operator positioned in the operator station so that an operator can control the multi-directional movement of the omni-directional wheels, the extension and retraction of the fork lift frame, and the elevation of the fork lift.

8. A fork lift apparatus comprising:
an elongate base having a front, a rear, and first and second sides extending between the front and the rear, the first side being positioned substantially opposite the second side and having a recess formed in a medial portion thereof to thereby define a recessed medial base portion;
a first pair of spaced-apart fork lift frame guide rails connected to a respective side wall of the recessed medial base portion;
a fork lift frame positioned to overlie the recessed medial base portion and slidably connect to the first pair of fork lift frame guide rails so that the fork lift frame is positioned between a retracted position and an extended position as the fork lift frame slidably moves along the first pair of fork lift frame guide rails;
a fork lift connected to the fork lift frame and including a lift base to support the fork lift during movement between the retracted position and the extended position of the fork lift frame;
a plurality of omni-directional wheels positioned adjacent a bottom portion of the elongate base;
a controller to control the movement of the plurality of omni-directional wheels, the fork lift frame, and the fork lift; and
a drive assembly connected to the elongate base, the fork lift frame, the fork lift, the plurality of omni-directional wheels, and the controller to drive the plurality of omni-directional wheels, the fork lift frame, and the fork lift responsive to the controller.

9. The fork lift apparatus as defined in claim 8, wherein the recess is positioned to extend inwardly from outer surface peripheries of the first side of the elongate base toward the second side of the elongate base so that a rear wall of the recess is positioned adjacent the second side of the elongate base to thereby define a recessed medial base portion of the elongate base and wherein the side wall of the recessed medial body portion is connected to and extends outwardly from the rear wall of the recessed medial body portion toward the outer surface peripheries of the first side of the elongate base.

10. The fork lift apparatus as defined in claim 9, wherein the fork lift frame further comprises a pair of spaced-apart and opposing side frame members each positioned to slidably connect to a respective one of the first pair of spaced-apart fork lift frame guide rails and a brace member connected to and extending between upper end portions of the pair of side frame members.

11. The fork lift apparatus as defined in claim 10, wherein the lift base of the fork lift further comprises a plurality of wheels connected thereto to thereby define a wheeled lift base and wherein the fork lift further comprises a second pair of spaced-apart fork lift guide rails connected to and extending upwardly from the wheeled lift base, a fork guide positioned to slidably engage the second pair of fork lift guide rails and adapted to be positioned between an elevated and a lowered position, and a pair of spaced-apart prong members positioned to slidably connect to the fork guide so that the pair of prong members move between an open position and a closed position.

12. The fork lift apparatus as defined in claim 11, further comprising an operator station connected to the fork lift frame positioned to be elevated so that an operator positioned therein can have an unobstructed view over a load when positioned on the pair of prong members, the controller being connected to the operator station so that the operator can control the movement of the plurality of omni-directional wheels, the fork lift frame, and the fork lift from the operator station.

13. The fork lift apparatus as defined in claim 12, wherein the retracted position of the fork lift frame is further defined by the fork lift frame being positioned closely adjacent the rear wall of the recessed medial base portion and wherein the extended position of the fork lift frame is further defined by the fork lift frame being positioned spaced-apart from the rear wall of the recessed medial base portion and adjacent the outer surface peripheries of the first side of the elongate base.

14. The fork lift apparatus as defined in claim 13, wherein the rear wall of the recessed medial body portion further comprises a ballast beam to thereby balance the fork lift apparatus when the load is positioned on the fork lift.

15. The fork lift apparatus as defined in claim 14, wherein the plurality of wheels connected to the wheeled lift base are adapted to move in a forward direction or a rearward direction when positioned in contact with a support surface.

16. The fork lift apparatus as defined in claim 15, further comprising an operator station connector connected to the fork lift frame to connect the operator station to the fork lift frame, the operator station connector comprising a first and a second operator station connector, the first operator station connector positioned to connect to the fork lift frame and the second operator station connector positioned to connect to the operator station and slidably engage the first operator station connector to thereby connect the operator station to the fork lift frame.

17. The fork lift apparatus as defined in claim 16, wherein the operator station is elevated to a position substantially higher than the load positioned on the pair of prong members and further comprises an operator station access connected to the operator station and the fork lift frame for providing ready access to the operator station.

18. The fork lift apparatus as defined in claim 17, wherein the controller further comprises a stick that is responsive to the operator positioned in the operator station so that an operator can control the multi-directional movement of the omni-directional wheels, the extension and retraction of the fork lift frame, and the elevation of the fork lift.

19. A fork lift apparatus comprising:
an elongate base having a front, a rear, and first and second sides extending between the front and the rear, the first side positioned substantially opposite the second side;
a fork lift frame connected to the elongate base and including fork lift frame guide means for guiding the fork lift frame between an extended position and a retracted position;
a fork lift connected to the fork lift frame and including a lift base, a fork guide positioned to overlie the lift base and having a pair of spaced-apart prong members connected thereto, and fork lift guide means positioned to overlie the lift base for guiding the fork guide between an elevated position and a lowered position; and
an operator station connected to an upper portion of the fork lift frame to provide an operator with an unobstructed view over a load when positioned on the fork lift.

20. The fork lift apparatus as defined in claim 19, wherein the elongate base further comprises a recess formed in a medial portion thereof, the recess extending inwardly from outer surface peripheries of the first side of the elongate base toward the second side of the elongate base so that a rear wall of the recess is positioned adjacent the second side to thereby define a recessed medial base portion of the elongate base.

21. The fork lift apparatus as defined in claim 20, wherein the recessed medial base portion further includes a first pair of spaced-apart fork lift frame guide rails each connected to a respective side wall of the recessed medial base portion, each side wall being connected to and extending outwardly from the rear wall toward the outer surface peripheries.

22. The fork lift apparatus as defined in claim 21, wherein the fork lift frame guide means further comprises a pair of spaced-apart and opposing side frame members each positioned to slidably connect to a respective one of the first pair of spaced-apart fork lift frame guide rails and to extend upwardly therefrom to position the fork lift frame between a retracted position and an extended position as the fork lift frame slidably moves along the first pair of fork lift frame guide rails.

23. The fork lift apparatus as defined in claim 22, wherein the lift base of the fork lift is adapted to support the fork lift during movement between the retracted position and the extended position of the fork lift frame, the lift base further comprising a plurality of wheels connected thereto to thereby define a wheeled lift base.

24. The fork lift apparatus as defined in claim 23, wherein the fork lift guide means further comprises a second pair of spaced-apart fork lift guide rails connected to and extending upwardly from the wheeled lift base to receive and move the fork guide between the elevated position and the lowered position, the pair of spaced-apart prong members positioned to slidably connect to the fork guide so that the pair of prong members are adapted to move between an open position and a closed position.

25. The fork lift apparatus as defined in claim 24, further comprising a plurality of omni-directional wheels positioned adjacent a bottom portion of the elongate base to thereby provide multi-directional movement to the elongate base.

26. The fork lift apparatus as defined in claim 25, wherein the operator station further comprises a controller to control the movement of the plurality of omni-directional wheels, the fork lift frame, and the fork lift.

27. The fork lift apparatus as defined in claim 26, further comprising a drive assembly connected to the elongate base, the fork lift frame, the fork lift, the plurality of omni-directional wheels, and the controller to drive the plurality of omni-directional wheels, the fork lift frame, and the fork lift responsive to the controller.

28. The fork lift apparatus as defined in claim 27, wherein the retracted position of the fork lift frame is further defined by the fork lift frame being positioned closely adjacent the rear wall of the recessed medial base portion and wherein the extended position of the fork lift frame is further defined by the fork lift frame being positioned spaced-apart from the rear wall of the recessed medial base portion and adjacent the outer surface peripheries of the first side of the elongate base.

29. The fork lift apparatus as defined in claim 28, wherein the rear wall of the recessed medial body portion further comprises a ballast beam to thereby balance the fork lift apparatus when the load is positioned on the fork lift.

30. The fork lift apparatus as defined in claim 29, wherein the plurality of wheels connected to the wheeled lift base are adapted to move in a forward direction or a rearward direction when positioned in contact with a support surface.

31. The fork lift apparatus as defined in claim 30, further comprising an operator station connector connected to the fork lift frame to connect the operator station to the fork lift frame, the operator station connector comprising a first and a second operator station connector, the first operator station connector positioned to connect to the fork lift frame and the second operator station connector positioned to connect to the operator station and slidably engage the first operator station connector to thereby connect the operator station to the fork lift frame.

32. The fork lift apparatus as defined in claim 31, wherein the operator station is elevated to a position substantially higher than the load positioned on the pair of prong members and further comprises an operator station access connected to the operator station and the fork lift frame for providing ready access to the operator station.

33. The fork lift apparatus as defined in claim 32, wherein the controller further comprises a stick that is responsive to the operator positioned in the operator station so that an operator can control the multi-directional movement of the omni-directional wheels, the extension and retraction of the fork lift frame, and the elevation of the fork lift.

34. A method of positioning a load within a predetermined narrow area using a fork lift apparatus having an elongate base with a longitudinal axis, the method comprising:
longitudinally moving the fork lift apparatus in a first predetermined direction along a longitudinal axis of the narrow area so that the longitudinal axis of the elongate base is positioned parallel to the longitudinal axis of the narrow area;
extending a fork lift from a retracted position to engage and lift the load; and
laterally moving the fork lift apparatus in a second predetermined direction so that the longitudinal axis of the elongate base is positioned substantially perpendicular to the longitudinal axis of the narrow area.

35. The method as defined in claim 34, further comprising moving the fork lift apparatus in a third predetermined direction so that the longitudinal axis of the elongate base is transverse to the longitudinal and lateral axes of the predetermined narrow area.

36. The method as defined in claim 35, further comprising retracting the fork lift from an extended position so that the load positioned on the fork lift overlies the elongate base.

37. The method as defined in claim 36, further comprising unloading the fork lift by extending the fork lift to an extended position, positioning the load on a support surface, and retracting the fork lift to a retracted position.

38. A method of positioning a load within a predetermined narrow area using a fork lift apparatus having an elongate base with a longitudinal axis, the method comprising:
diagonally moving the fork lift apparatus in a predetermined direction so that the longitudinal axis of the elongate base is positioned transverse to a longitudinal axis of the narrow area; and
extending a fork lift from a retracted position to engage and lift the load.

39. The method as defined in claim 38, further comprising longitudinal moving the fork lift apparatus in another predetermined direction along the longitudinal axis of the narrow area so that the longitudinal axis of the elongate base is positioned parallel to the longitudinal axis of the narrow area.

40. The method as defined in claim 39, further comprising laterally moving the fork lift apparatus in another predetermined direction so that the longitudinal axis of the elongate base is positioned substantially perpendicular to the longitudinal axis of the narrow area.

41. The method as defined in claim 40, further comprising viewing an area surrounding the predetermined narrow area from an elevated and stationary position when the load is lifted.

42. The method as defined in claim 41, further comprising maneuvering the load within the predetermined narrow area while maintaining visibility of the area surrounding the predetermined narrow area.
